(19) United States
(12) Patent Application Publication
(10) Pub. No.: US 2011/0274243 A1
(43) Pub. Date: Nov. 10, 2011

(54) Positioning Device For Analyzing A Double Seam Cross-Section And The Double Seam Pleat Formation Using X-Rays

(75) Inventor: Michael Lenko, Wandlitz (DE)

(73) Assignee: CMC Kuhnke GmbH, Berlin (DE)

(21) Appl. No.: 13/126,135

(22) PCT Filed: Sep. 24, 2009
(86) PCT No.: PCT/DE2009/001347

§ 371 Date: Jul. 19, 2011

(30) Foreign Application Priority Data
Oct. 27, 2008 (DE) 10 2008 053 825.6

(51) Int. Cl. G01N 23/18

(52) U.S. Cl. 378/58

(57) ABSTRACT

A positioning device for the examination of a double seam cross section and wrinkle formation by X-rays comprising an X-ray source with a first stop associated with the latter for a can to be examined in the area of the exit opening for the X-rays and detectors for receiving the X-rays. The can to be examined can be clamped in relation to the X-ray source by at least three stops offset with respect to one another, wherein two of these stops can be actively changed with respect to their position to adapt to different can diameters and to the desired incident radiation angle.

The invention is directed to a positioning device for the examination of a double seam cross section and the double seam wrinkle formation of a can by means of X-rays according to the preamble of patent claim 1.

Two basic methods are known for the measurement of a double seam cross section, namely, on the one hand, an examination method which damages the double seam and, on the other hand, a non-destructive examination.

DE 199 30 536 C2 can be cited as an example of the first method mentioned above.

The above-cited reference discloses a device for measuring a double seam cross section in which this double seam cross section is made accessible by sawing out a segment of the can with a radially extending saw cut surface. The can is then placed top side down on a measuring table. The cut surface is illuminated by an illumination device and can be recorded by a video camera.

On the other hand, the double seam cross section can be examined by X-rays without destroying the double seam.

For this purpose, an X-ray is directed to the double seam at a determined angle and is received by a correspondingly arranged detector. U.S. Pat. No. 6,953,933 or GB 2 215 834 A are cited as examples for this.

With respect to this examination by means of X-rays, a distinction is made between seam measurement and the examination of the wrinkle formation or “wrinkle measurement.”

The angle at which the X-rays strike the double seam differs in these examination methods.

For seam measurement, the X-rays impinge directly radially on the double seam, whereas in the examination of the wrinkle formation a segment is examined through oblique irradiation.

The radiation source is arranged in a stationary manner, and this also applies to the required detectors which are arranged at different positions. Further, it is necessary to orientate the can and double seam with respect to the radiation source so that the required angle is provided.

Therefore, a displacement or different positioning of the can is indispensable.

However, one very important factor in both examination methods is that the examination can be carried out not only at one location on the can, but rather new areas must be made available constantly for the entire examination, particularly in a reproducible manner, by rotating the can around its own axis.

Manual repositioning does not lead to reproducible results even with the proposed stops.

Therefore, it is the object of the invention to provide a device for positioning a can for examining the double seam cross section and the wrinkle formation which works in a reproducible manner and accordingly can also be used in particular for automated examinations.

This object is met according to the invention by a positioning device for the examination of a double seam cross section by means of X-rays comprising an X-ray source with a first stop associated with the latter for a can to be examined in the area of the exit opening for the X-rays and detectors for receiving the X-rays, characterized in that the can to be examined can be clamped relative to the X-ray source by means of at least three stops which are offset with respect to one another, wherein two of these stops can be actively changed with respect to their position in order to adapt to different can diameters and to the desired incident radiation angle.

For this purpose, it is provided that the second stop is a stop surface which is displaceable perpendicular to the exit direction of the X-rays toward and away from the latter.

It is further provided that the third stop comprises a rotating device with drivable rollers which can be adjusted externally to the can circumference and with an anvil which can be adjusted on the radially outer side to the inner circumference of the can.

The active change of position of the second stop surface can be achieved in that the stop surface is displaceable by means of an actuating drive.

The rotating device is constructed in such a way that the rotating device is arranged with the anvil on a slide which is displaceable on a guide which in turn faces in direction of the X-ray source at an angle between 20 and 30 degrees, particularly 27.2 degrees, and that the slide is rotatable or swivelable relative to the guide around an axis perpendicular to the latter.

According to another embodiment, the second stop surface has a horizontal support for the double seam.

The operation of the device will be described in the following with reference to the drawings.

It is taken for granted that, naturally, many different can diameters will occur in the examination of double seams, i.e., the device must be easily and quickly adaptable to these different diameters.

Further, it must be taken into account that—as was mentioned above—the opening for the emergence of the X-rays is fixed as is the position of the detectors.

Accordingly, a stop surface, designated as first stop surface 12, is first provided for the can 2 to be examined in the area of the exit 1 of the X-rays.

A stop surface 3 which is arranged perpendicular to the X-ray exit opening and which is displaceable on this axis 4, i.e., in direction toward and away from the X-ray source, is provided as second stop.

This stop surface 3 is crucial because it forms the reference line for the different can diameters.

In this way, the can is displaced laterally to adapt to different can diameters and to carry out seam measurement or wrinkle measurement so that, to this end, the X-rays no longer impinge radially on the double seam, but rather on a segment.

The device according to the invention includes not only this displaceable stop surface 3 but also a rotating device 9 which is arranged opposite from the latter and by which another can segment can be made available for examination, i.e., the can can be rotated around its axis.

This rotating device 9 encloses the double seam with two driven rollers 11 and rotates the can 2 by a given angle. The rotating device 9 also includes an anvil 10 which is arranged spatially between the rollers 11 and encloses the double seam from the inner side. The anvil 10, whose displacement direction is radial with respect to the can, lifts the can 2 used for examination slightly from the two stop surfaces 3, 12 so that it can be rotated without scraping along the stop surfaces.

After the can is rotated, the anvil 10 moves back, i.e., disengages from the inside wall of the seam, and the can is then clamped in against the two stop surfaces 3, 12 under radial pressure of the rollers 11 which are provided for the rotation.

The anvil 10 and the rollers 11 are arranged on a slide 8 so that a common displacement can be carried out in direction toward and away from the can by means of the slide 8 in order to adapt to different can diameters.

Further to this end the rotating device 9 is rotatable or swivelable around a vertical axis on the slide.

The cooperation of the two stop surfaces, i.e., the stop surface in the area of the exit opening for the X-rays and the displaceable stop surface, together with the displaceable rotating device ensure an exact and, above all, reproducible positioning of the can to be examined in relation to the X-ray source.

1.-6. (canceled)

7. A positioning device for the examination of a double seam cross section and wrinkle formation by X-rays comprising:
an X-ray source;
at least one detector for receiving the X-rays;
a first stop associated with the X-ray source for a can to be examined in proximate to an exit opening for the X-rays and the detectors for receiving the X-rays;
a second and third stop that are offset with respect to one another configured to clamp the can to be examined relative to the X-ray source the third stop comprises:
a rotating device with drivable rollers that can be adjusted externally to the can circumference having an anvil that can be adjusted on the radially outer side to the inner circumference of the can,
wherein at least two of these stops can be actively changed with respect to their position to adapt to different can diameters and to a desired incident radiation angle.

8. The positioning device according to claim 7, wherein the second stop is a stop surface that is displaceable perpendicular to the exit direction of the X-rays toward and away from the exit direction of the X-rays.

9. The positioning device according to claim 8, wherein at least the second stop surface is displaceable by an actuating drive.

10. The positioning device according to claim 7, wherein the rotating device is arranged with the anvil on a slide that is displaceable on a guide that faces toward the X-ray source at an angle between about 20 and 30 degrees, the slide being at least one of rotatable and swivelable on the guide around a vertical axis.

11. The positioning device according to claim 7, wherein the second stop surface includes a horizontal support for the double seam.

12. The positioning device according to claim 7, wherein the rotating device is arranged with the anvil on a slide that is displaceable on a guide that faces toward the X-ray source at an angle of 27.2 degrees.
